(19) United States
(12) Patent Application Publication
(10) Pub. No.: US 2022/0071202 A1
(43) Pub. Date: Mar. 10, 2022

(54) ENCAPSULATED PESTICIDE

(71) Applicant: PANGAEA AGROCHEMICALS LIMITED, Cambridge, Cambridgeshire (GB)

(72) Inventor: Graham HAIGH, Huddersfield, Yorkshire (GB)

(21) Appl. No.: 17/414,289

(22) PCT Filed: Dec. 20, 2019
(86) PCT No.: PCT/GB2019/053659

§ 371 Date: Jun. 15, 2021

(30) Foreign Application Priority Data
Dec. 21, 2018 (GB) 1821031.0

(51) Int. Cl. A01N 25/26; B01J 13/04; A01N 25/30; A01N 57/20

(52) U.S. Cl. CPC A01N 25/26; A01N 57/20; A01N 25/30; B01J 13/04

(57) ABSTRACT

A method for encapsulating a pesticide(for example glyphosate) includes the steps of (a) mixing a first biopolymer which s an alginate with a viscosity from 4 to 100 centipoise (a 1% aqueous solution at 20 centigrade) and a second biopolymer in solution, (b) adding the product of step (a) to a solution of pesticide, and (c) adding a surfactant to the product of step (b).

The present invention relates to a method for encapsulating a pesticide, and in particular to a method which avoids the need for forming an emulsion. It also relates to an encapsulated pesticide formed according to the method, and to methods of using the pesticide with or without an adjuvant. More particularly it relates to a pesticide which is a herbicide.

Herbicides are commonly used in agriculture to improve the productivity and quality of the grown product. The global market for herbicides is estimated to reach $31.5 billion by 2020. Asia-Pacific is the dominant market accounting for two fifth of herbicide use, whereas North America region equates to one-third of global revenue generated by the herbicide market.

At present, the most widely used herbicide in the world is glyphosate, which has global sales amounting to more than $10 billion per year due to low cost production and low environmental impact.

As a result of the prolonged use of herbicides, weeds are becoming resistant and this is increasing exponentially with over 217 weed species presently resistant around the world. In most cases, it is estimated that weed resistance will emerge within three years on a piece of land which has been treated with a given herbicide.

Current solutions are either to develop novel herbicides or switch from glyphosate-ready to glufosinate-ready crops. Both alternatives are expensive and there are no guarantees that the weed will not become resistant after 3-5 years. In case of the herbicide glufosinate, weed-resistance has already been reported. The first cases of weed-resistance were reported in 2009 and increasing use of the herbicide is likely to result in widespread resistance.

Other alternatives are to use higher dosages of glyphosate, which could be detrimental to the environment or in extreme circumstances manual removal of the weeds, which is labour intensive. Both alternatives lead to higher costs or danger of ruining the fertile land.

EP 1 499 183 B2 (Rothamsted Research Institute Limited et al.) discloses a method for preventing or reducing resistance to a pesticide of a substrate pest, which method comprises administering to the substrate or the pest a metabolic enzyme inhibitor (such as piperonyl butoxide—PBO) and (substantially simultaneously) a pesticide (such as a pyrethroid insecticide) encapsulated in a degradable capsule. The capsule prevents an effective dose of the pesticide from being absorbed by the pest until the inhibitor has had time to begin its inhibiting effect on the substrate. The formulation used in this case is Karate Zeon® which is a PVA-encapsulated insecticide (lambda-cyhalothrin) produced by Syngenta.

EP 0427991 A1 (Sumitomo Chemical Co.) discloses an insecticidal and/or acaricidal and/or nematicidal composition which is a mixture of an encapsulated part which is formed of water-insoluble microcapsules and a flowable part which is emulsified or suspended in water.

US 2015/320036 A1 discloses a process for obtaining biopolymeric nanoparticles containing Azadirachta indica A. Juss (Neem), which comprises, in Phase I, preparing an aqueous emulsion of Neem oil and extracts, in Phase II, preparing a biopolymer solution in organic solvent, followed by mixture of both Phases I and II, and, in Phase III, preparing an aqueous emulsion of a surfactant and adding it to the Phase I and II mixture, affording a nanoparticle suspension which is stabilized. Biopolymeric nanoparticles and powder microparticles obtained are also described.

US 2016/0330952 A1 discloses methods for the encapsulation of volatile organic compounds by formation of stable emulsions of the volatile organic compound that are mixed with encapsulating polymer solutions and then formed into ultrafine fibers. The ultrafine fibers containing the encapsulated volatile organic compounds can be formed into a variety of formats for use to preserve perishable products.

The present applicant has filed International Patent Application No. PCT/GB2018/051864 (unpublished at the date of filing the present application) which seeks to provide an improved encapsulated pesticide. The present application seeks to provide yet a further improvement, and in particular an improved method which is commercially suitable for industrial production of the encapsulated pesticide.

In accordance with a first aspect of the present invention, there is provided a method for encapsulating a pesticide, including the steps of combining a pesticide in solution with a first biopolymer and a second biopolymer and a surfactant. Preferably, the method includes the steps of:
(a) mixing the first biopolymer and the second biopolymer in solution,
(b) adding the product of step (a) to a solution of pesticide, and
(c) adding the surfactant to the product of step (b).

In a particularly preferred embodiment, the first biopolymer is an alginate, the second biopolymer is a pectin and the surfactant is a cocoamine surfactant.

It has been discovered that the inventive method is able to produce an encapsulated pesticide without needing to produce an emulsion (either oil-in-water or water-in-oil). This has substantial advantages both environmentally (avoiding the need to use organic solvents) and commercially (because expensive washing steps are not needed). In addition, the process can be performed in a single vessel, avoiding the need for centrifugation or filtering steps. The product also has suitable pesticide release properties.

The first biopolymer is preferably an alginate with a viscosity from 4 to 100 centipoise (for e.g. a 1 w/v % solution). The use of a low viscosity alginate ensures that the resulting product has suitable rheological properties for application to plants (for example).

In a preferred embodiment, calcium ions may be added as it is believed (without wishing to be constrained by theory) that these can result in a more stable encapsulated product. The use of hard water is believed to provide a sufficient level of calcium ions.

A number of preferred embodiments of the invention will now be described with reference to and as illustrated in the accompanying drawings, in which:

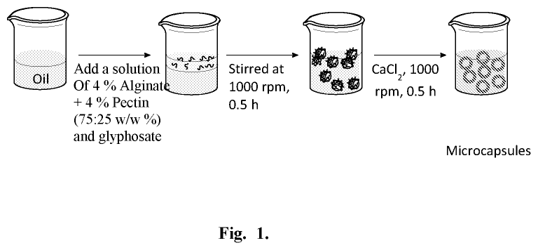

FIG. 1 is a schematic diagram illustrating the preparation of microcapsules via the Emulsion-gelation method; and

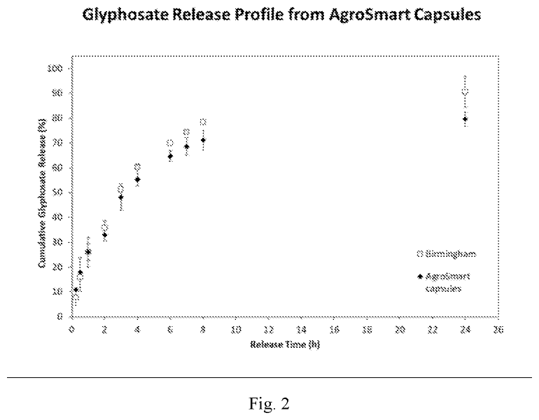

FIG. 2 is a graph showing the cumulative glyphosate release over time from capsules encapsulated in accordance with the invention.

Experimental

Materials

All the chemicals were purchased from either Aldrich or Fisher Scientific, whereas the solvents were purchased from Fisher Scientific.
Alginic acid sodium salt from brown algae (Aldrich; product number A0682).
Pectin from citrius peel with galactaronic acid ≥74% (Aldrich; product number P9135).
Chitosan from crab shell, with at least 85% deacylated (Aldrich; product number 48165).
Gelatine from bovine skin with around 75 bloom (Aldrich).
Calcium chloride anhydrous powder (Fisher Scientific; product number 1.02378.2500).
Glacial acetic acid (Fisher Scientific; A/0360/PB17).
Phosphoric acid (Aldrich; product number 79617).
Glyphosate (99%, Aldrich: product number 455251).
The 67% glyphosate isopropylammonium solution was supplied by Pangea Chemicals.
Isopropylamine (Aldrich: product number 471291).
Sunflower oil (supermarket brand; ASDA).

### COMPARATIVE EXAMPLE A

Emulsion-Gelation Method
Aqueous solutions of 4% (w/w) of coating materials were prepared in distilled water. The only exception being chitosan where 1% solution was prepared in 1% (v/v) acetic acid, which was also prepared in distilled water.
For the formulations containing the mixed coatings; the mixed coating solutions were prepared by stirring the required w/w ratios of the individual coating solutions for 5 min prior to the addition of glyphosate salt to ensure homogeneous mixture.
An aqueous solution of coating material (25 g) was mixed with aqueous solution of 67% (w/w) glyphosate isopropylammonium solution (5 g) using a magnetic stirrer at 200 rpm for 2 min.
The resultant solution was added dropwise to a stirred 250 ml breaker containing sunflower oil (100 ml) to form an emulsion using a homogeniser (IKA) at 1000 rpm with blade diameter 27 mm.
After 30 min, calcium chloride (1 g) powder was added slowly over 10 min. Small portions of powder (0.1 g) was sprinkled using a stainless steel spatula to ensure the powder was evenly distributed over the reaction vessel. The calcium chloride reacts instantaneously when it comes in contact with the coating material.
The resultant reaction mixture was further stirred for 30 min at 1000 rpm using a homogenizer. Observe formation of white capsules settling to the bottom of the breaker.
The resultant reaction mixture was separated in two centrifuge tubes (50 ml) and centrifuged for 10 min at 3300 rpm.
The supernatant was discarded.
Hexane (50 ml) was added to each centrifuge tube (50 ml volume) and the suspension centrifuged for 10 min at 3300 rpm.
The supernatant was decanted and the process was repeated once again.
The microcapsules were placed under high vacuum overnight to remove remaining solvent residue.

### EXAMPLE B

Experimental preparation of Glyphosate 120 g/l CS—1000Lts

Step One: Premix A

In a stainless-steel ribbon blender, mix the following components:

30 Kilograms low viscosity sodium alginate (1% solution with a viscosity of less than 20 cps)

10 Kilograms pectin, specification of greater 74% Galacturonic acid which suggests the esterification is less than 26%

Mix the above for 30 minutes at a rate between 5 and 10 RPM

Step Two: Premix B

In a clean stainless-steel mixing vessel with suitable extraction, mixing and temperature, add 267 Kilograms Glyphosate-Isopropylammonium salt 620 g/kg (to give 122 g/l approx.)

Warm and maintain the above 45 to 55° C.

Start the propeller mixer at a speed to produce a vortex in the liquid.

Slowly add Premix A (40 Kilograms) into the vortex at a speed so no obvious lumps form.

Once added, slow the mixer to a speed such that no additional air is added into the solution, remove the heat source and allow the product to stir whilst the temperature returns to ambient.

**** Sample liquid, all Premix A must have dissolved into the Glyphosate IPA Salt, this can take between 2 and 24 hours subject to Alginate/Pectin source.

Step Three: Final Product

Take 307 Kilograms of the product of Step 2

Maintain slow agitation, do not incorporate any air bubbles.

Slowly add at a rate of 100 Kilograms/Hour 622.5 Kilograms WHO standard hard water (The calcium required comes from the water hardness)

Then add 160.0 Kilograms Surfactant LKD 1559

2.5 Kilograms Acid Blue 9 concentrate

0.1 Kilograms Citrus Burst WS

Total=1092.1 Kilograms/1000 Litres

Results

Capsule Characterisation

Encapsulation Efficiency (ee)
The ee for the capsules were determined via thoroughly grinding the capsules (100 mg) periodically for 1 min after intervals of 15 min over 1 h using a mortar and pestle in an aqueous solution of potassium dihydrogen phosphite buffer (5 ml).
After 1 h, the ground mixtures were filtered (0.45 μm) and samples were run by HPLC to determine the glyphosate concentration. Each experiment was repeated three times for each capsule.

The results for the capsules of Comparative Example A and Example B are shown in Table 1 below:

| Capsules produced by: | EE (%) | Active load (%) |
|---|---|---|
| Example A | 83 ± 6 | 13 ± 1 |
| Example B | 74 ± 4 | 10 ± 1 |

Glyphosate Release Studies

These were carried out using HPLC. Capsules to be tested were placed in a dialysis tube (1g in 50 ml water) and mixed at 150 rpm at 25° C. and 35% humidity.

Capsules were then sampled at different times to analyse glyphosate release using HPLC.

The release profile for the capsules of Comparative Example A (labelled “Birmingham”) and Example B (labelled “AgroSmart capsules”) are shown in FIG. 1 below. It can be seen that comparable release profiles are obtained despite the difference in encapsulation methods.

All optional and preferred features and modifications of the described embodiments and dependent claims are usable in all aspects of the invention taught herein. Furthermore, the individual features of the dependent claims, as well as all optional and preferred features and modifications of the described embodiments are combinable and interchangeable with one another.

The disclosures in UK patent application number 1821031.0 from which this application claims priority, and in the abstract accompanying this application are incorporated herein by reference.

1. A method for encapsulating a pesticide, including the steps of
(a) mixing a first biopolymer which is an alginate with a viscosity from 4 to 100 centipoise (a 1% aqueous solution at 20 centigrade) and a second biopolymer in solution,
(b) adding the product of step (a) to a solution of pesticide, and
(c) adding a surfactant to the product of step (b).

2. A method as claimed in claim 1, wherein the second biopolymer is a pectin or chitosan.

3. A method as claimed in claim 2, wherein the pectin is a citrus pectin.

4. A method as claimed in claim 2, wherein the pectin is in the form of an ester.

5. A method as claimed in claim 4, wherein the degree of esterification up to 30%.

6. A method as claimed in claim 1, wherein the surfactant is a cocoamine surfactant.

7. A method as claimed in claim 1, wherein the amount of surfactant is from 3% to 30%

8. A method as claimed in claim 7, wherein the amount of surfactant is about 16%.

9. A method as claimed in claim 1, wherein the ratio of the first to the second biopolymer is from 9:1 to 1:9.

10. A method as claimed in claim 9, wherein the ratio of the first to the second biopolymer is about 3:1.

11. A method as claimed in claim 1, wherein in step (b) the product is stirred at a rate of stirring from 500 to 3000 RPM.

12. A method as claimed in claim 11, wherein the product is continuously stirred from 30 minutes to 24 hours.

13. A method as claimed in claim 11, wherein the product is stirred or agitated under a blanket of inert gas, optionally nitrogen.

14. A method as claimed in claim 11, wherein the product is stirred with a propeller, an anchor, a dissolver, a paddle, a swivel, a beater and turbine, a four-bladed impeller or a gate mixer.

15. A method as claimed in claim 1, wherein the pesticide is glyphosate, glufosinate, or any water-soluble pesticide.

16. A method as claimed in claim 15, wherein the pesticide is glyphosate in the form of a salt of ammonium, diammonium, dimethylammonium, isopropylammonium, potassium or sesquisodium.

17. A method as claimed in claim 1, wherein step (b) is carried out at a temperature from 40° C. to 60° C.

18. A method as claimed claim 1 which is carried out in aqueous solution.

19. A method as claimed in claim 1, wherein the pesticide is provided in the form of a 62% solution in water.

20. A method as claimed in claim 1 which is carried out as a continuous process or as a batch process.

21. A method as claimed in claim 1 in which the amount of pesticide in the final product is from 0.2 w/v % to 40 w/v %.

22. An encapsulated pesticide obtained by:
(a) mixing a first biopolymer which is an alginate with a viscosity from 4 to 100 centipoise (a 1% aqueous solution at 20 centigrade) and a second biopolymer in solution,
(b) adding the product of step (a) to a solution of pesticide, and
(c) adding a surfactant to the product of step (b).

23. An encapsulated pesticide as claimed in claim 22 with an activity of 0.36 w/v %, 0.72 w/v %, 12 w/v % or 18 w/v %.

24. A method of applying the product of claim 22 to a plant including the step of applying the product together with an adjuvant.

25. A method as claimed in claim 24, wherein the adjuvant is PBO.

26. A method of applying the product of claim 22 to a plant including the step of applying the product in the absence of an adjuvant.
